(19) United States
(12) Patent Application Publication
(10) Pub. No.: US 2010/0065200 A1
(43) Pub. Date: Mar. 18, 2010

(54) Tetrabenzodiazadiketoperylene pigments in laser welding

(76) Inventors: Josephd E. Sarver, Erial, NJ (US); Damien Thurber Cole, Drexel Hill, PA (US); Colin Dennis Campbell, Claymont, DE (US)

Correspondence Address: Ciba Corporation;Patent Department, 540 White Plains Road, P.O. Box 2005, Tarrytown, NY, 10591, US

(21) Appl. No.: 12/380,934

(22) Filed: Mar. 5, 2009

Related U.S. Application Data
(62) Division of application No. 11/589,585, filed on Oct. 30, 2006, now abandoned.
(60) Provisional application No. 60/759,732, filed on Jan. 18, 2006.

(51) Int. Cl. B29C 65/16

(52) U.S. Cl. 156/272.8

(57) ABSTRACT

A method method for laser welding a layered article wherein IR irradiation is passed through a composition containing a tetrabenzodiazadiketoperylene pigment or dye to the surface of an underlying substrate which contain an IR absorbing material, generating enough heat at the point of irradiation to melt together the two materials.

This application is a divisional of U.S. application Ser. No. 11/589,585, pending, filed Oct. 30, 2006, which application is incorporated herein its entirety by reference.

A method for producing laser welded articles is provided wherein infra-red (IR) radiation from a laser is passed through a darkly colored layer containing black and brown tetrabenzodiazadiketoperylene pigments and dyes which are transparent to much of the (IR) radiation to an underlying substrate containing an IR absorbing material, such as a carbon black pigmented polymer to generate enough heat at the point of irradiation to “laser weld”, or melt the two materials together.

Materials which possess infra-red (IR) reflectance characteristics have proven to be valuable in many current applications. Such materials reduce IR-induced heat buildup and find use in automotive and marine coatings, containers, colored plastics such as vinyl siding etc. Thermally robust compositions also find use in inorganic and organic glazing and aerospace, architectural and other glass and ceramic decorative applications where reduced heat buildup is desired.

Other applications which make use of IR reflective materials include protective camouflage for military applications.

U.S. Pat. Nos. 6,171,383 and 6,221,147, both hereby incorporated in their entirety by reference, disclose IR reflective bismuth manganese oxide green pigments with improved heat buildup properties.

U.S. Pat. No. 5,028,643, hereby incorporated in its entirety by reference, discloses tetrabenzodiazadiketoperylene pigments and a method for their preparation.

U.S. Pat. No. 6,989,056, hereby incorporated in its entirety by reference, discloses IR reflective black pigment compositions containing a halogenated copper phthalocyanine and a perylenetetracarboxylic acid diimide.

In spite of the advancements made in the art, there remains a need for new, stable, IR reflective compositions.

It has been found that incorporating tetrabenzodiazadiketoperylene pigments and dyes (TBDKP) into plastics or coatings render the plastics or coatings IR reflective. The pigments and dyes of the present invention allow for the preparation of dark colored (including black and brown), IR reflective substrates.

As used herein, the term “IR reflectance” means the reflectance properties of a material at wavelengths above about 700 nm. That is, electromagnetic radiation at wavelengths above about 700 nm is reflected. The reflectance characteristics of the articles produced via this invention are highly advantageous in applications where heat buildup due to the absorption of IR radiation is to be minimized and where detection by IR sensors is to be minimized.

The same pigments and dyes, which are darkly colored, for example shades of black and brown, are also found to be transparent to much of the infra-red (IR) radiation not reflected. Incorporating the pigments or dyes into, for example, a layer which is in contact with a substrate containing an IR absorbing material, such as a carbon black pigmented polymer, allows one to pass IR radiation, as from a laser, through the layer containing the pigments of the invention to the underlying substrate generating enough heat at the point of irradiation to “laser weld”, or melt the two materials together.

### DESCRIPTION OF THE INVENTION

A method is provided for preparing an infra red (IR) reflective organic or inorganic substrate which method comprises the incorporation into the substrate, or the application onto the surface of the substrate, a composition containing an amount of a tetrabenzodiazadiketoperylene pigment or dye (TBDKP) of formula I effective to impart to the organic or inorganic substrate an infra red reflectance of greater than about 50 percent at wavelengths between about 800 and about 1,200 nm,

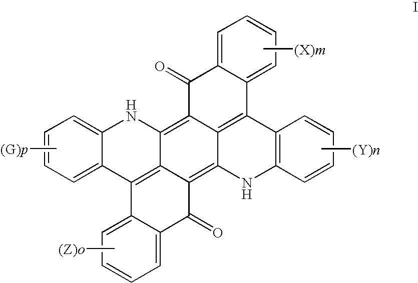

wherein

X, Y, Z and G independently of each other are

C₁₋₁₂ alkyl or branched alkyl, C₃₋₆ cycloalkyl, C₇₋₁₂ aralkyl, C₆₋₁₀ aryl, C₃₋₉ saturated or unsaturated heterocycle, halogen, —OR, CF₃, —COOR, —CONR′R, NO₂, NR′R, SO₃H or SO₂NR′R;

R and R′, independently of each other are hydrogen, C₁₋₈ alkyl or branched alkyl, C₃₋₆ cycloalkyl, C₆₋₁₀ aromatic or C₇₋₁₂ aralkyl, and when attached to nitrogen, R and R′ can also, together with the nitrogen atom to which they are attached, form a 5-, 6- or 7-membered ring which is uninterrupted or interrupted by —O—, NH or —N(C₁₋₄alkyl);

and m, n, o and p are independently 0, 1, 2, 3 or 4, when m, n, o or p is 2, 3 or 4, each X, Y, Z or G substituent may each be a different group as defined above.

The inorganic or organic substrate may be, for example, a naturally occurring polymer or a synthetic polymer; for example, a thermoplastic, elastomeric, inherently crosslinked or crosslinked polymer.

For example, a method which method comprises incorporating into a thermoplastic, elastomeric, crosslinked or inherently crosslinked polymer an amount of a tetrabenzodiazadiketoperylene pigment or dye (TBDKP) of formula I effective to impart to the thermoplastic, elastomeric, crosslinked or inherently crosslinked polymer an infra red reflectance of greater than about 50 percent at wavelengths between about 800 and about 1,200 nm.

For example, X, Y, Z and G independently of each other are C₁₋₁₂ alkyl or branched alkyl, C₇₋₁₂ aralkyl, C₆₋₁₀ aryl, F, Cl, Br, I, —OR, —COOR, —CONR′R, NO₂, NR′R, SO₃H or SO₂NR′R and m, n, o and p are independently 0, 1, 2, 3 or 4.

For example, X, Y, Z and G independently of each other are C₁₋₁₂ alkyl or branched alkyl, C₇₋₁₂ aralkyl, C₆₋₁₀ aryl, F, Cl, Br, —OR, —COOR, —CONR′R, NO₂, NR′R, SO₃H or SO₂NR′R and m, n, o and p are independently 0, 1 or 2.

For example, X, Y, Z and G independently of each other are C₁₋₁₂ alkyl or branched alkyl, F, Cl, —OR, —NO₂, NR′R or SO₃H and m, n, o and p are independently 0, 1 or 2.

For example, m, n, o and p are each 0 and the tetrabenzodiazadiketoperylene pigment of formula I is

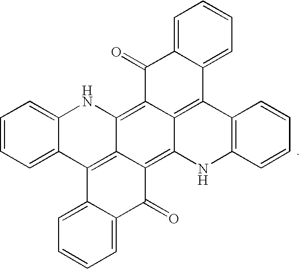

Alkyl or branched alkyl is straight or branched chain of the specified number of carbon atoms and is for example methyl, ethyl, n-propyl, n-butyl, sec-butyl, tert-butyl, n-hexyl, n-octyl, 2-ethylhexyl, n-nonyl, n-decyl, n-undecyl, n-dodecyl.

The composition containing the tetrabenzodiazadiketoperylene pigment or dye may be composed entirely of the pigment or dye, or other materials as disclosed herein may also be present.

The tetrabenzodiazadiketoperylene pigments and dyes of the present invention are prepared according to the methods of U.S. Pat. No. 5,028,643.

As used herein, the term “IR reflectance” means the reflectance properties of a material at wavelengths above about 700 nm. That is, electromagnetic radiation at wavelengths above about 700 nm is reflected. Substrates containing the present pigments or dyes, or articles coated with compositions containing the present pigments or dyes, typically have an IR reflectance of greater than about 50 percent at wavelengths between about 800 and about 1,200 nm, for example at about 1,000 nm, and have measurable IR reflectance at higher wavelengths, for example, between about 1200 and 2000 nm.

These reflectance characteristics are highly advantageous in applications where heat buildup due to the absorption of IR radiation is to be minimized and where detection by IR sensors is to be minimized.

Typically, the TBDKP pigment or dye is incorporated into a composition comprising a thermoplastic, thermoset, elastomeric, inherently crosslinked or crosslinked polymer.

The polymer may be, for example, in the form of a film, sheet, injection-moulded article, extruded workpiece, fiber, laminate, felt or woven fabric. The polymer may also be part of a coating composition.

The TBDKP pigment or dye is either incorporated into the substrate directly or applied to the surface of the substrate.

When applied to the surface of a substrate the TBDKP pigment or dye may be part of a coating composition. The coating can comprise any coating system, or even a preformed film, which both adheres to the substrate and is compatible with the TBDKP pigment or dye, for example, auto coatings, marine coatings, paints, inks, laminates, receiving layers for printing applications, or other protective or decorative coatings including coatings or films used in glazing applications. The TBDKP pigment or dye may also be part of a fabric treatment.

Examples of thermoplastic, thermoset, elastomeric, inherently crosslinked or crosslinked polymers into which the pigments or dyes of the present invention may be incorporated into or coated onto are listed below.

1. Polymers of mono- and di-olefins, for example polypropylene, polyisobutylene, polybutene-1, poly-4-methylpentene-1, polyisoprene or polybutadiene and also polymerisates of cyclo-olefins, for example of cyclopentene or norbornene; and also polyethylene (which may optionally be crosslinked), for example high density polyethylene (HDPE), high density polyethylene of high molecular weight (HDPE-HMW), high density polyethylene of ultra-high molecular weight (HDPE-UHMW), medium density polyethylene (MDPE), low density polyethylene (LDPE), and linear low density polyethylene (LLDPE), (VLDPE) and (ULDPE).

Polyolefins, that is to say polymers of mono-olefins, as mentioned by way of example in the preceding paragraph, especially polyethylene and polypropylene, can be prepared by various processes, especially by the following methods:

a) by free radical polymerisation (usually at high pressure and high temperature);

b) by means of a catalyst, the catalyst usually containing one or more metals of group IVb, Vb, VIb or VIII. Those metals generally have one or more ligands, such as oxides, halides, alcoholates, esters, ethers, amines, alkyls, alkenyls and/or aryls, which may be either π- or σ-coordinated. Such metal complexes may be free or fixed to carriers, for example to activated magnesium chloride, titanium (III) chloride, aluminium oxide or silicon oxide. Such catalysts may be soluble or insoluble in the polymerisation medium. The catalysts can be active as such in the polymerisation or further activators may be used, for example metal alkyls, metal hydrides, metal alkyl halides, metal alkyl oxides or metal alkyl oxanes, the metals being elements of group(s) Ia, IIa and/or IIIa. The activators may have been modified, for example, with further ester, ether, amine or silyl ether groups.

2. Mixtures of the polymers mentioned under 1), for example mixtures of polypropylene with polyisobutylene, polypropylene with polyethylene (for example PP/HDPE, PP/LDPE) and mixtures of different types of polyethylene (for example LDPE/HDPE).

3. Copolymers of mono- and di-olefins with one another or with other vinyl monomers, for example ethylene/propylene copolymers, linear low density polyethylene (LLDPE) and mixtures thereof with low density polyethylene (LDPE), propylene/butene-1 copolymers, propylene/isobutylene copolymers, ethylene/butene-1 copolymers, ethylene/hexene copolymers, ethylene/methylpentene copolymers, ethylene/heptene copolymers, ethylene/octene copolymers, propylene/butadiene copolymers, isobutylene/isoprene copolymers, ethylene/alkyl acrylate copolymers, ethylene/alkyl methacrylate copolymers, ethylene/vinyl acetate copolymers and copolymers thereof with carbon monoxide, or ethylene/acrylic acid copolymers and salts thereof (ionomers), and also terpolymers of ethylene with propylene and a diene, such as hexadiene, dicyclopentadiene or ethylidenenorbornene; and also mixtures of such copolymers with one another or with polymers mentioned under 1), for example polypropylene-ethylene/propylene copolymers, LDPE-ethylene/vinyl acetate copolymers, LDPE-ethylene/acrylic acid copolymers, LLDPE-ethylene/vinyl acetate copolymers, LLDPE-ethylene/acrylic acid copolymers and alternately or randomly structured polyalkylene-carbon monoxide copolymers and mixtures thereof with other polymers, for example polyamides.

4. Hydrocarbon resins (for example C₅-C₉) including hydrogenated modifications thereof (for example tackifier resins) and mixtures of polyalkylenes and starch.

5. Polystyrene, poly(p-methylstyrene), poly(α-methylstyrene).

6. Copolymers of styrene or α-methylstyrene with dienes or acrylic derivatives, for example styrene/butadiene, styrene/acrylonitrile, styrene/alkyl methacrylate, styrene/butadiene/alkyl acrylate and methacrylate, styrene/maleic anhydride, styrene/acrylonitrile/methyl acrylate; high-impact-strength mixtures consisting of styrene copolymers and another polymer, for example a polyacrylate, a diene polymer or an ethylene/propylene/diene terpolymer; and also block copolymers of styrene, for example styrene/butadiene/styrene, styrene/isoprene/styrene, styrene/ethylene-butylene/styrene or styrene/ethylene-propylene/styrene.

7. Graft copolymers of styrene or α-methylstyrene, for example styrene on polybutadiene, styrene on polybutadiene/styrene or polybutadiene/acrylonitrile copolymers, styrene and acrylonitrile (or methacrylonitrile) on polybutadiene; styrene, acrylonitrile and methyl methacrylate on polybutadiene; styrene and maleic anhydride on polybutadiene; styrene, acrylonitrile and maleic anhydride or maleic acid imide on polybutadiene; styrene and maleic acid imide on polybutadiene, styrene and alkyl acrylates or alkyl methacrylates on polybutadiene, styrene and acrylonitrile on ethylene/propylene/diene terpolymers, styrene and acrylonitrile on polyalkyl acrylates or polyalkyl methacrylates, styrene and acrylonitrile on acrylate/butadiene copolymers, and mixtures thereof with the copolymers mentioned under 6), such as those known, for example, as so-called ABS, MBS, ASA or AES polymers.

8. Halogen-containing polymers, for example polychloroprene, chlorinated rubber, chlorinated and brominated copolymer of isobutylene/isoprene (halobutyl rubber), chlorinated or chlorosulfonated polyethylene, copolymers of ethylene and chlorinated ethylene, epichlorohydrin homo- and co-polymers, especially polymers of halogen-containing vinyl compounds, for example polyvinyl chloride, polyvinylidene chloride, polyvinyl fluoride, polyvinylidene fluoride; and copolymers thereof, such as vinyl chloride/vinylidene chloride, vinyl chloride/vinyl acetate or vinylidene chloride/vinyl acetate.

9. Polymers derived from α,β-unsaturated acids and derivatives thereof, such as polyacrylates and polymethacrylates, or polymethyl methacrylates, polyacrylamides and polyacrylonitriles impact-resistant-modified with butyl acrylate.

10. Copolymers of the monomers mentioned under 9) with one another or with other unsaturated monomers, for example acrylonitrile/butadiene copolymers, acrylonitrile/alkyl acrylate copolymers, acrylonitrile/alkoxyalkyl acrylate copolymers, acrylonitrile/vinyl halide copolymers or acrylonitrile/alkyl methacrylate/butadiene terpolymers.

11. Polymers derived from unsaturated alcohols and amines or their acyl derivatives or acetals, such as polyvinyl alcohol, polyvinyl acetate, stearate, benzoate or maleate, polyvinylbutyral, polyallyl phthalate, polyallylmelamine; and the copolymers thereof with olefins mentioned in Point 1.

12. Homo- and co-polymers of cyclic ethers, such as polyalkylene glycols, polyethylene oxide, polypropylene oxide or copolymers thereof with bisglycidyl ethers.

13. Polyacetals, such as polyoxymethylene, and also those polyoxymethylenes which contain comonomers, for example ethylene oxide; polyacetals modified with thermoplastic polyurethanes, acrylates or MBS.

14. Polyphenylene oxides and sulfides and mixtures thereof with styrene polymers or polyamides.

15. Polyurethanes derived from polyethers, polyesters and polybutadienes having terminal hydroxyl groups on the one hand and aliphatic or aromatic polyisocyanates on the other hand, and their initial products.

16. Polyamides and copolyamides derived from diamines and dicarboxylic acids and/or from aminocarboxylic acids or the corresponding lactams, such as polyamide 4, polyamide 6, polyamide 6/6, 6/10, 6/9, 6/12, 4/6, 12/12, polyamide 11, polyamide 12, aromatic polyamides derived from m-xylene, diamine and adipic acid; polyamides prepared from hexamethylenediamine and iso- and/or tere-phthalic acid and optionally an elastomer as modifier, for example poly-2,4,4-trimethylhexamethylene terephthalamide or poly-m-phenylene isophthalamide. Block copolymers of the above-mentioned polyamides with polyolefins, olefin copolymers, ionomers or chemically bonded or grafted elastomers; or with polyethers, for example with polyethylene glycol, polypropylene glycol or polytetramethylene glycol. Also polyamides or copolyamides modified with EPDM or ABS; and polyamides condensed during processing (“RIM polyamide systems”).

17. Polyureas, polyimides, polyamide imides, polyether imides, polyester imides, polyhydantoins and polybenzimidazoles.

18. Polyesters derived from dicarboxylic acids and dialcohols and/or from hydroxy-carboxylic acids or the corresponding lactones, such as polyethylene terephthalate, polybutylene terephthalate, poly-1,4-dimethylolcyclohexane terephthalate, polyhydroxy-benzoates, and also block polyether esters derived from polyethers with hydroxyl terminal groups; and also polyesters modified with polycarbonates or MBS.

19. Polycarbonates and polyester carbonates.

20. Polysulfones, polyether sulfones and polyether ketones.

21. Crosslinked polymers derived from aldehydes on the one hand and phenols, urea or melamine on the other hand, such as phenol-formaldehyde, urea-formaldehyde and melamine-formaldehyde resins.

22. Drying and non-drying alkyd resins.

23. Unsaturated polyester resins derived from copolyesters of saturated and unsaturated dicarboxylic acids with polyhydric alcohols, and also vinyl compounds as crosslinking agents, and also the halogen-containing, difficultly combustible modifications thereof.

24. Crosslinkable acrylic resins derived from substituted acrylic esters, e.g. from epoxy acrylates, urethane acrylates or polyester acrylates.

25. Alkyd resins, polyester resins and acrylate resins that are crosslinked with melamine resins, urea resins, isocyanates, isocyanurates, polyisocyanates or epoxy resins.

26. Crosslinked epoxy resins derived from aliphatic, cycloaliphatic, heterocyclic or aromatic glycidyl compounds, e.g. products of bisphenol-A diglycidyl ethers, bisphenol-F diglycidyl ethers, that are crosslinked using customary hardeners, e.g. anhydrides or amines with or without accelerators.

27. Natural polymers, such as cellulose, natural rubber, gelatin, or polymer-homologously chemically modified derivatives thereof, such as cellulose acetates, propionates and butyrates, and the cellulose ethers, such as methyl cellulose; and also colophonium resins and derivatives.

28. Mixtures (polyblends) of the afore-mentioned polymers, for example PP/EPDM, polyamide/EPDM or ABS, PVC/EVA, PVC/ABS, PVC/MBS, PC/ABS, PBTP/ABS, PC/ASA, PC/PBT, PVC/CPE, PVC/acrylates, POM/thermoplastic PUR, PC/thermoplastic PUR, POM/acrylate, POM/MBS, PPO/HIPS, PPO/PA 6.6 and copolymers, PA/HDPE, PA/PP, PA/PPO, PBT/PC/ABS or PBT/PET/PC.

The thermoplastic, elastomeric, crosslinked or inherently crosslinked polymer is, for example, a polyolefin, polyamide, polyurethane, polyacrylate, polyacrylamide, polyvinyl alcohol, polycarbonate, polystyrene, polyester, polyacetal, a natural or synthetic rubber or a halogenated vinyl polymer such as PVC. The polymer may be a co-polymer, a polymer blend or part of a composite.

The TBDKP pigments and dyes of the instant invention may be incorporated into polymer resins according a variety of known methods. For example, the compounds may be added as an individual component during blending, for example, dry blending of the resin prior to prior to processing, or the compound may be added as a blend, master batch, flush, or other concentrate in another substance prior to processing. The compounds may also be added during processing steps. Standard process steps for polymer resins are well known in the literature and include extrusion, coextrusion, compression molding, Brabender melt processing, film formation, injection molding, blow molding, other molding and sheet forming processes, fiber formation etc.

The compounds of formula I are also incorporated via dry blending, surface impregnation, suspension, dispersion and other methods known in coatings technology.

When the pigments or dyes of the instant invention are used in a film, the film is applied to the surface by, for example, the use of an adhesive, or co-extruded onto the surface. A preformed film may also be applied with heat which includes calendaring, melt applications and shrink wrapping.

When a substrate is coated with an IR reflecting coating comprising a TBDKP pigment or dye, the coating typically comprises a polymeric binder which can in principle be any binder customary in industry, for example those described in Ullmann's Encyclopedia of Industrial Chemistry, 5th Edition, Vol. A18, pp. 368-426, VCH, Weinheim 1991. In general, it is a film-forming binder based on a thermoplastic or thermosetting resin, for example, a thermosetting resin. Examples thereof are alkyd, acrylic, acrylamide, polyester, styrenic, phenolic, melamine, epoxy and polyurethane resins.

For example, non-limiting examples of common coating binders useful in the present invention include silicon containing polymers, fluorinated polymers, unsaturated polyesters, unsaturated polyamides, polyimides, crosslinkable acrylic resins derived from substituted acrylic esters, e.g. from epoxy acrylates, urethane acrylates, polyester acrylates, polymers of vinyl acetate, vinyl alcohol and vinyl amine. The coating binder polymers may be co-polymers, polymer blends or composites.

Coatings are frequently crosslinked with, for example, melamine resins, urea resins, isocyanates, isocyanurates, polyisocyanates, epoxy resins, anhydrides, poly acids and amines, with or without accelerators.

The binder can be a cold-curable or hot-curable binder. In many instances it is desirable to use tetrabenzodiazadiketoperylene pigment rather than dye. In these instances, the binder can be a cold-curable or hot-curable binder provided that the temperature is not high enough to cause dissolution of the tetrabenzodiazadiketoperylene pigment; the addition of a curing catalyst may be advantageous. Suitable catalysts which accelerate curing of the binder are described, for example, in Ullmann's Encyclopedia of Industrial Chemistry, Vol. A18, p.469, VCH Verlagsgesellschaft, Weinheim 1991.

The binder may be a surface coating resin which dries in the air or hardens at room temperature. Exemplary of such binders are nitrocellulose, polyvinyl acetate, polyvinyl chloride, unsaturated polyester resins, polyacrylates, polyurethanes, epoxy resins, phenolic resins, and especially alkyd resins. The binder may also be a mixture of different surface coating resins. Provided the binders are curable binders, they are normally used together with a hardener and/or accelerator.

Examples of coating compositions containing specific binders are:

1. coatings based on cold- or hot-crosslinkable alkyd, acrylate, polyester, epoxy or melamine resins or mixtures of such resins, if desired with addition of a curing catalyst;

2. two-component polyurethane coatings based on hydroxyl-containing acrylate, polyester or polyether resins and aliphatic or aromatic isocyanates, isocyanurates or polyisocyanates;

3. one-component polyurethane coatings based on blocked isocyanates, isocyanurates or polyisocyanates which are deblocked during baking, if desired with addition of a melamine resin;

4. one-component polyurethane coatings based on a Trisalkoxycarbonyltriazine crosslinker and a hydroxyl group containing resin such as acrylate, polyester or polyether resins;

5. one-component polyurethane coatings based on aliphatic or aromatic urethaneacrylates or polyurethaneacrylates having free amino groups within the urethane structure and melamine resins or polyether resins, if necessary with curing catalyst;

6. two-component coatings based on (poly)ketimines and aliphatic or aromatic isocyanates, isocyanurates or polyisocyanates;

7. two-component coatings based on (poly)ketimines and an unsaturated acrylate resin or a polyacetoacetate resin or a methacrylamidoglycolate methyl ester;

8. two-component coatings based on carboxyl- or amino-containing polyacrylates and polyepoxides;

9. two-component coatings based on acrylate resins containing anhydride groups and on a polyhydroxy or polyamino component;

10. two-component coatings based on acrylate-containing anhydrides and polyepoxides;

11. two-component coatings based on (poly)oxazolines and acrylate resins containing anhydride groups, or unsaturated acrylate resins, or aliphatic or aromatic isocyanates, isocyanurates or polyisocyanates;

12. two-component coatings based on unsaturated polyacrylates and polymalonates;

13. thermoplastic polyacrylate coatings based on thermoplastic acrylate resins or externally crosslinking acrylate resins in combination with etherified melamine resins;

14. paint systems based on siloxane-modified or fluorine-modified acrylate resins.

Acrylic, methacrylic and acrylamide polymers and co-polymers dispersible in water are readily used as a binder in the present invention, for example, acrylic, methacrylic and acrylamide dispersion polymers and co-polymers.

For example, coatings or films comprising acrylate polymers are useful in the instant invention.

The coating composition can also comprise further components, examples being solvents, pigments, dyes, plasticizers, stabilizers, thixotropic agents, drying catalysts and/or levelling agents. Examples of possible components are those described in Ullmann's Encyclopedia of Industrial Chemistry, 5th Edition, Vol. A18, pp. 429-471, VCH, Weinheim 1991.

Possible drying catalysts or curing catalysts are, for example, organometallic compounds, amines, amino-containing resins and/or phosphines. Examples of organometallic compounds are metal carboxylates, especially those of the metals Pb, Mn, Co, Zn, Zr or Cu, or metal chelates, especially those of the metals Al, Ti or Zr, or organometallic compounds such as organotin compounds, for example.

Examples of metal carboxylates are the stearates of Pb, Mn or Zn, the octoates of Co, Zn or Cu, the naphthenates of Mn and Co or the corresponding linoleates, resinates or tallates.

Examples of metal chelates are the aluminium, titanium or zirconium chelates of acetylacetone, ethyl acetylacetate, salicylaldehyde, salicylaldoxime, o-hydroxyacetophenone or ethyl trifluoroacetylacetate, and the alkoxides of these metals.

Examples of organotin compounds are dibutyltin oxide, dibutyltin dilaurate or dibutyltin dioctoate.

Examples of amines are, in particular, tertiary amines, for example tributylamine, triethanolamine, N-methyldiethanolamine, N-dimethylethanolamine, N-ethylmorpholine, N-methylmorpholine or diazabicyclooctane (triethylenediamine) and salts thereof. Further examples are quaternary ammonium salts, for example trimethylbenzyl-ammonium chloride.

Amino-containing resins are simultaneously binder and curing catalyst. Examples thereof are amino-containing acrylate copolymers.

The curing catalyst used can also be a phosphine, for example triphenylphosphine.

The coating compositions can also be radiation-curable coating compositions. In this case, the binder essentially comprises monomeric or oligomeric compounds containing ethylenically unsaturated bonds, which after application are cured by actinic radiation, i.e. converted into a crosslinked, high molecular weight form. Where the system is UV-curing, it generally contains a photoinitiator as well. Corresponding systems are described in the abovementioned publication Ullmann's Encyclopedia of Industrial Chemistry, 5th Edition, Vol. A18, pages 451-453. In radiation-curable coating compositions, the novel stabilizers can also be employed without the addition of sterically hindered amines.

The coating may also be a radiation-curable, solvent-free formulation of photopolymerisable compounds. Illustrative examples are mixtures of acrylates or methacrylates, unsaturated polyester/styrene mixtures or mixtures of other ethylenically unsaturated monomers or oligomers.

The coating compositions can comprise an organic solvent or solvent mixture in which the binder is soluble. The coating composition can otherwise be an aqueous solution or dispersion. The vehicle can also be a mixture of organic solvent and water. The coating composition may be a high-solids paint or can be solvent-free (e.g. a powder coating material). Powder coatings are, for example, those described in Ullmann's Encyclopedia of Industrial Chemistry, 5th Ed., A18, pages 438-444. The powder coating material may also have the form of a powder-slurry (dispersion of the powder preferably in water).

Multilayer systems are possible where the tetrabenzodiazadiketoperylene pigment or dye may reside in a coating which is then itself coated with another coating, such as a protective coating.

When used in a coating, the compounds of formula I are incorporated into the coating via techniques common in the art.

The coating composition according to the invention can be applied to any desired substrate, for example to metal, wood, plastic, composite, glass or ceramic material substrates by the customary methods, for example by brushing, spraying, pouring, draw down, spin coating, dipping or electrophoresis; see also Ullmann's Encyclopedia of Industrial Chemistry, 5th Edition, Vol. A18, pp. 491-500.

The TBDKP pigment or dye is present in the IR-reflective composition in an “effective amount”, that is an amount that provides both the desired level of coloration for the substrate or coating and also provides the desired IR-reflectance. For example, the TBDKP pigment or dye is present in an amount of about 0.01 to about 50% by weight of tetrabenzodiazadiketoperylene pigment or dye based on the total weight of the composition, for example, 0.01-15%, or 0.1-10% or 0.1-5% by weight based on the total weight of the composition. In the case of a coating, the composition is the fully dried and cured coating.

It is also envisioned that when applied to the surface of a substrate, the TBDKP pigment or dye may be present in even higher amounts, even approaching 100%, such as in a thin layer, or a layer which is part of a laminate structure.

A composition comprising the present TBDKP pigments or dyes may also optionally have incorporated therein or applied thereto other additives such as antioxidants, UV absorbers, hindered amine or other light stabilizers, phosphites or phosphonites, benzo-furan-2-ones, thiosynergists, polyamide stabilizers, metal stearates, nucleating agents, fillers, reinforcing agents, lubricants, emulsifiers, dyes, pigments, dispersants, optical brighteners, flame retardants, antistatic agents, blowing agents and the like.

The present invention also provides an IR reflective composition or article comprising an organic or inorganic substrate, typically a polymeric substrate, and an amount of a tetrabenzodiazadiketoperylene pigment or dye of formula I effective to impart to the organic or inorganic substrate an infra red reflectance of greater than about 50 percent at wavelengths between about 800 and about 1,200 nm. The IR reflective composition or article may be a coating, film, sheet or molded or otherwise shaped article.

For Example, an infra red reflective composition comprising a thermoplastic, elastomeric, crosslinked or inherently crosslinked polymer and an amount of a tetrabenzodiazadiketoperylene pigment or dye (TBDKP) of formula I effective to impart to the composition an infra red reflectance of greater than about 50 percent at wavelengths between about 800 and about 1,200 nm.

Also provided is an IR reflective article comprising a substrate which is coated with an IR reflective coating or film comprising a TBDKP pigment or dye of formula I.

A further embodiment of the invention provides a method for laser welding a layered article wherein a TBDKP pigment or dye of formula I is incorporated into a polymeric composition which is in contact with a surface of a substrate, preferably a polymeric substrate, containing an IR absorbing material, such as a carbon black pigmented polymer, IR radiation, as from a laser, is passed through the layer containing the pigments of the invention to the underlying IR absorbing material generating enough heat at the point of irradiation to “laser weld”, that is melt together the two materials.

The lasers used are commonly available lasers which emit at wavelengths between about 700 and about 2000 nm, for example, between about 800 and about 1500 nm.

### Examples

### Example 1

A mixture of 1 gram of Tetrabenzodiazadiketoperylene and 999 grams of Basel ProFax 6301 polypropylene is extruded using a 35 mm twin-screw extruder at 200° C. then injection injection molded into 2 mm thick chips at temperatures of at least 250° C. The IR reflectance of the resulting black chips is measured and found to be between 60-80% from 800 to 1200 nm, between 40% and 60% from 1300 to 1400 nm and over 30% at about 1600 nm.

### EXAMPLE 2

The procedure of Example 1 is repeated using 1 gram of chlorinated tetrabenzodiazadiketoperylene to produce brown polypropylene chips with similar IR reflectance.

### EXAMPLE 3

A mixture of 2.3 grams of a toner of Tetrabenzodiazadiketoperylene, 1.2 grams of DISPERBYK 161, 16.9 grams of an acrylic mill base and 39.3 grams of a letdown is milled with 100 grams of 2 mm glass beads using a SKANDEX mill. The resulting paint is separated from the beads.

A drawdown of the paint using a 100 micron wet film wired bar and a KCC automatic film applicator is prepared and dried over a white/black leneta card. The IR reflectance of the chips is measured and found to be between greater than 80% from 800 to 1300 nm, between 60% and 80% from 1300 to 1500 nm, greater than 60% at about 1800 nm, greater than 50% at about 2000 nm.

What is claimed is:

1. A method for laser welding an article wherein IR radiation from a laser is passed through a darkly colored layer containing a black and brown tetrabenzodiazadiketoperylene pigment or dye of formula I to a surface of an underlying substrate containing an IR absorbing material generating enough heat at the point of irradiation to melt together the darkly colored layer and underlying substrate 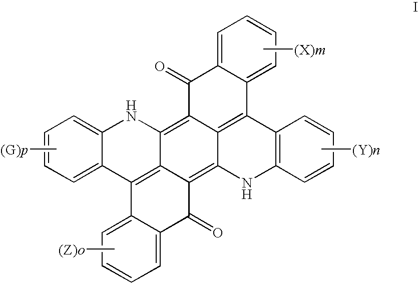
wherein
X, Y, Z and G independently of each other are
C₁₋₁₂ alkyl or branched alkyl, C₃₋₆ cycloalkyl, C₇₋₁₂ aralkyl, C₆₋₁₀ aryl, C₃₋₉ saturated or unsaturated heterocycle, halogen, —OR, CF₃, —COOR, —CONR′R, NO₂, NR′R, SO₃H or SO₂NR′R;
R and R′, independently of each other are hydrogen, C₁₋₈ alkyl or branched alkyl, C₃₋₆ cycloalkyl, C₆₋₁₀ aromatic or C₇₋₁₂ aralky, and when attached to nitrogen, R and R′ can also, together with the nitrogen atom to which they are attached, form a 5-, 6- or 7-membered ring which is uninterrupted or interrupted by —O—, NH or —N(C₁₋₄alkyl);
and m, n, o and p are independently 0, 1, 2, 3 or 4, when m, n, o or p is 2, 3 or 4, each X, Y, Z or G substituent may each be a different group as defined above or m, n, o and p are each 0.

2. A method according to claim 1 wherein the darkly colored layer containing a black or brown tetrabenzodiazadiketoperylene pigment or dye of formula I is a polymeric composition.

3. A method according to claim 2, wherein the polymer of the polymeric composition is a polyolefin, polyamide, polyurethane, polyacrylate, polyacrylamide, polyvinyl alcohol, polycarbonate, polystyrene, polyester, polyacetal, a natural or synthetic rubber or a halogenated vinyl polymer.

4. A method according to claim 2 wherein the underlying substrate is a polymeric substrate.

5. A method according to claim 1 wherein IR absorbing material of the underlying substrate is carbon black.

6. A method according to claim 1, wherein X, Y, Z and G independently of each other are C₁₋₁₂ alkyl or branched alkyl, C₇₋₁₂ aralkyl, C₆₋₁₀ aryl, F, Cl, Br, I, —OR, —COOR, —CONR′R, NO₂, NR′R, SO₃H or SO₂NR′R and m, n, o and p are independently 0, 1, 2, 3 or 4.

7. A method according to claim 1, wherein X, Y, Z and G independently of each other are C₁₋₁₂ alkyl or branched alkyl, F, Cl, —OR, —NO₂, NR′R or SO₃H and m, n, o and p are independently 0, 1 or 2.

8. A method according to claim 1, wherein the tetrabenzodiazadiketoperylene pigment or dye of formula I is a pigment.

9. A method according to claim 2, wherein the tetrabenzodiazadiketoperylene pigment or dye is incorporated into a polymer which polymer is in the form of a film, sheet or other molded or shaped article.

10. A method according to claim 9 wherein the tetrabenzodiazadiketoperylene pigment or dye is incorporated into the polymer by dry blending, extrusion, coextrusion, compression molding, injection molding, blow molding or surface impregnation.

11. The method according to claim 1, wherein the laser has an emission at a wavelength between about 700 and about 2000 nm.
